(19) United States
(12) Patent Application Publication
(10) Pub. No.: US 2013/0182687 A1
(43) Pub. Date: Jul. 18, 2013

(54) APPARATUS AND METHOD FOR CONTROLLING SECONDARY CELL UPLINK SYNCHRONIZATION STATES

(71) Applicants: Boon Loong Ng, Richardson, TX (US); Gerardus Johannes Petrus van Lieshout, Apeldoorn (NL); Kyeongin Jeong, Suwon-si (KR); Soenghun Kim, Youngin-si (KR); Jianzhong Zhang, Plano, TX (US)

(72) Inventors: Boon Loong Ng, Richardson, TX (US); Gerardus Johannes Petrus van Lieshout, Apeldoorn (NL); Kyeongin Jeong, Suwon-si (KR); Soenghun Kim, Youngin-si (KR); Jianzhong Zhang, Plano, TX (US)

(73) Assignee: Samsung Electronics Co., Ltd., Suwon-si (KR)

(21) Appl. No.: 13/554,893

(22) Filed: Jul. 20, 2012

Related U.S. Application Data
(60) Provisional application No. 61/512,855, filed on Jul. 28, 2011.
(60) Provisional application No. 61/512,783, filed on Jul. 28, 2011.

(51) Int. Cl. H04W 56/00

(52) U.S. Cl. CPC H04W 56/001
USPC 370/336

(57) ABSTRACT

A user equipment (UE) is configured to perform a method for controlling synchronization with a secondary cell (SCell). The method includes receiving a physical downlink control channel (PDCCH) order from an eNodeB associated with an SCell. The method also includes, in response to receiving the PDCCH order, transitioning from a first state where the UE considers the SCell in sync for an uplink transmission to a second state where the UE considers the SCell out of sync for the uplink transmission.

### CROSS-REFERENCE TO RELATED APPLICATION(S) AND CLAIM OF PRIORITY

The present application is related to U.S. Provisional Patent Application No. 61/512,855, filed Jul. 28, 2011, entitled “METHODS FOR CONTROLLING SCELL UL SYNCHRONIZATION STATES” and U.S. Provisional Patent Application No. 61/512,783, filed Jul. 28, 2011, entitled “ENHANCEMENT TO UE INITIATED RANDOM ACCESS PROCEDURE FOR LTE CARRIER AGGREGATION”. Provisional Patent Application Nos. 61/512,855 and 61/512,783 are assigned to the assignee of the present application and is hereby incorporated by reference into the present application as if fully set forth herein. The present application hereby claims priority under 35 U.S.C. §119(e) to U.S. Provisional Patent Application Nos. 61/512,855 and 61/512,783.

### TECHNICAL FIELD

The present application relates generally to wireless communication systems and, more specifically, to methods for controlling secondary cell uplink synchronization states.

### BACKGROUND

One of the objectives of Release 11 of the 3GPP Long Term Evolution (LTE) standard is to specify the support for the use of multiple timing advances for LTE uplink carrier aggregation. This is discussed in LTE Document No. RP-101421, titled “LTE Carrier Aggregation Enhancements”. A timing advance for uplink transmission is performed by the user equipment (UE) to achieve uplink timing synchronization with the network. The support for multiple timing advances for LTE uplink carrier aggregation is necessary for cellular deployment scenarios where two aggregated cells can undergo different channel propagation delay from the UE.

### SUMMARY

For use in a user equipment (UE), a method for controlling synchronization with a secondary cell (SCell) is provided. The method includes receiving a physical downlink control channel (PDCCH) order from an eNodeB associated with a SCell. The method also includes, in response to receiving the PDCCH order, transitioning from a first state where the UE considers the SCell in sync for an uplink transmission to a second state where the UE considers the SCell out of sync for the uplink transmission.

A user equipment (UE) configured to control synchronization with a secondary cell (SCell) is provided. The UE includes a processor configured to receive a physical downlink control channel (PDCCH) order from an eNodeB associated with a SCell. The processor is also configured to, in response to receiving the PDCCH order, transition the UE from a first state where the UE considers the SCell in sync for an uplink transmission to a second state where the UE considers the SCell out of sync for the uplink transmission.

For use in a user equipment (UE), a method for communicating with a secondary cell (SCell) is provided. The method includes initiating a random access procedure to a SCell, wherein completion of the random access procedure causes an eNodeB associated with the SCell to schedule an uplink transmission on the SCell. The method also includes transmitting on the uplink to the SCell according to the schedule.

A user equipment (UE) configured to communicate with a secondary cell (SCell) is provided. The UE includes a processor configured to initiate a random access procedure to a SCell, wherein completion of the random access procedure causes an eNodeB associated with the SCell to schedule an uplink transmission on the SCell. The processor is also configured to transmit on the uplink to the SCell according to the schedule.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a wireless network according to one embodiment of the present disclosure;

FIG. 2 illustrates a high-level diagram of a wireless transmit path according to an embodiment of this disclosure;

FIG. 3 illustrates a high-level diagram of a wireless receive path according to an embodiment of this disclosure;

FIG. 4 illustrates a network of primary and secondary cells according to one embodiment of this disclosure;

FIGS. 5A and 5B illustrate contention-based and non-contention-based random access procedures in a LTE system;

FIG. 6 illustrates a state diagram for secondary cell (SCell) activation/deactivation and uplink (UL) synchronization states for an Alternative 1;

FIG. 7 illustrates a state diagram for SCell activation/deactivation and UL synchronization states for an Alternative 2;

FIGS. 8 and 9 illustrate state diagrams that depict using a physical downlink control channel order to transition from State 3 to State 2, according to embodiments of this disclosure;

FIG. 10 illustrates a state diagram that depicts an enhancement to Alternative 2, according to an embodiment of this disclosure;

FIG. 11 illustrates the LTE Release 10 (“Rel-10”) activation/deactivation MAC control element design;

FIG. 12 illustrates a MAC control element according to one embodiment of this disclosure;

FIG. 13 illustrates a MAC control element according to another embodiment of this disclosure;

FIG. 14 illustrates a state diagram that depicts an enhancement to Alternative 2, according to an embodiment of this disclosure;

FIG. 15 illustrates the Timing Advance Command MAC control element in LTE Rel-10;

FIG. 16 illustrates a Timing Advance Command MAC control element according to one embodiment of this disclosure;

FIG. 17 illustrates a state diagram that depicts an enhancement to Alternative 2, according to an embodiment of this disclosure; and

FIG. 18 illustrates one example of a new MAC control element according to an embodiment of this disclosure.

### DETAILED DESCRIPTION

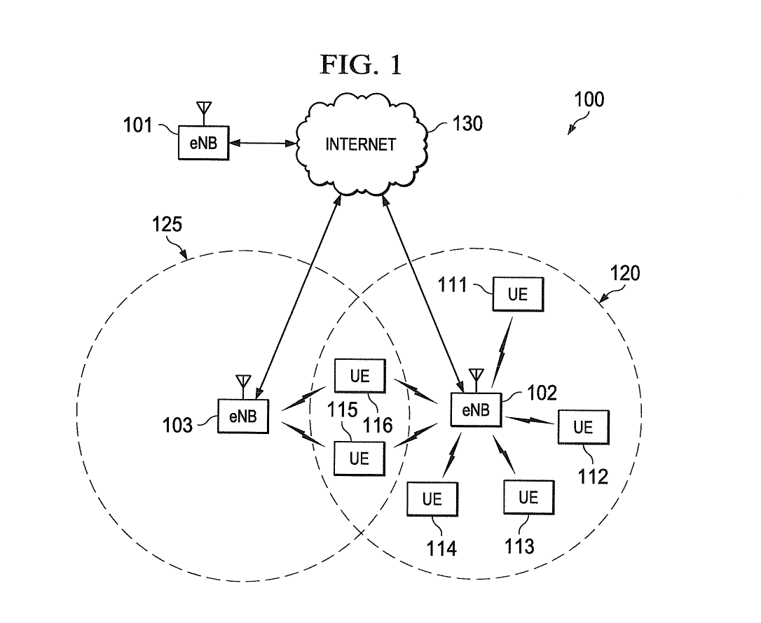

FIGS. 1 through 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The following documents and standards descriptions are hereby incorporated into the present disclosure as if fully set forth herein:

(i) LTE Document No. RP-101421, “LTE Carrier Aggregation Enhancements” (hereinafter “REF1”); (ii) Document No. R2-111840, “Initial Consideration on Multiple TA, CATT” (hereinafter “REF2”); (iii) 3GPP Technical Specification No. 36.300, version 10.3.0, March 2011 (hereinafter “REF3”); (iv) 3GPP Technical Report No. 36.814, version 9.0.0, March 2010 (hereinafter “REF4”); (v) 3GPP Technical Specification No. 36.321, version 10.2.0, June 2011 (hereinafter “REF5”); (vi) 3GPP Technical Specification No. 36.331, version 10.2.0, June 2011 (hereinafter “REF6”); (vii) Document No. R2-113234, “Maintaining UL Synchronization for Deactivated SCell” (hereinafter “REF7”); and (viii) Document No. R2-112819, “Time Alignment in Case of Multiple TA” (hereinafter “REF8”).

FIG. 1 illustrates a wireless network 100 according to one embodiment of the present disclosure. The embodiment of wireless network 100 illustrated in FIG. 1 is for illustration only. Other embodiments of wireless network 100 could be used without departing from the scope of this disclosure.

The wireless network 100 includes eNodeB (eNB) 101, eNB 102, and eNB 103. The eNB 101 communicates with eNB 102 and eNB 103. The eNB 101 also communicates with Internet protocol (IP) network 130, such as the Internet, a proprietary IP network, or other data network.

Depending on the network type, other well-known terms may be used instead of “eNodeB,” such as “base station” or “access point”. For the sake of convenience, the term “eNodeB” shall be used herein to refer to the network infrastructure components that provide wireless access to remote terminals.

The eNB 102 provides wireless broadband access to network 130 to a first plurality of user equipments (UEs) within coverage area 120 of eNB 102. The first plurality of UEs includes UE 111, which may be located in a small business; UE 112, which may be located in an enterprise; UE 113, which may be located in a WiFi hotspot; UE 114, which may be located in a first residence; UE 115, which may be located in a second residence; and UE 116, which may be a mobile device, such as a cell phone, a wireless laptop, a wireless PDA, or the like. UEs 111-116 may be any wireless communication device, such as, but not limited to, a mobile phone, mobile PDA and any mobile station (MS).

For the sake of convenience, the term “user equipment” or “UE” is used herein to designate any remote wireless equipment that wirelessly accesses an eNB, whether the UE is a mobile device (e.g., cell phone) or is normally considered a stationary device (e.g., desktop personal computer, vending machine, etc.). In other systems, other well-known terms may be used instead of “user equipment”, such as “mobile station” (MS), “subscriber station” (SS), “remote terminal” (RT), “wireless terminal” (WT), and the like.

The eNB 103 provides wireless broadband access to a second plurality of UEs within coverage area 125 of eNB 103. The second plurality of UEs includes UE 115 and UE 116. In some embodiment, eNBs 101-103 may communicate with each other and with UEs 111-116 using LTE or LTE-A techniques.

Dotted lines show the approximate extents of coverage areas 120 and 125, which are shown as approximately circular for the purposes of illustration and explanation only. It should be clearly understood that the coverage areas associated with base stations, for example, coverage areas 120 and 125, may have other shapes, including irregular shapes, depending upon the configuration of the base stations and variations in the radio environment associated with natural and man-made obstructions.

Although FIG. 1 depicts one example of a wireless network 100, various changes may be made to FIG. 1. For example, another type of data network, such as a wired network, may be substituted for wireless network 100. In a wired network, network terminals may replace eNBs 101-103 and UEs 111-116. Wired connections may replace the wireless connections depicted in FIG. 1.

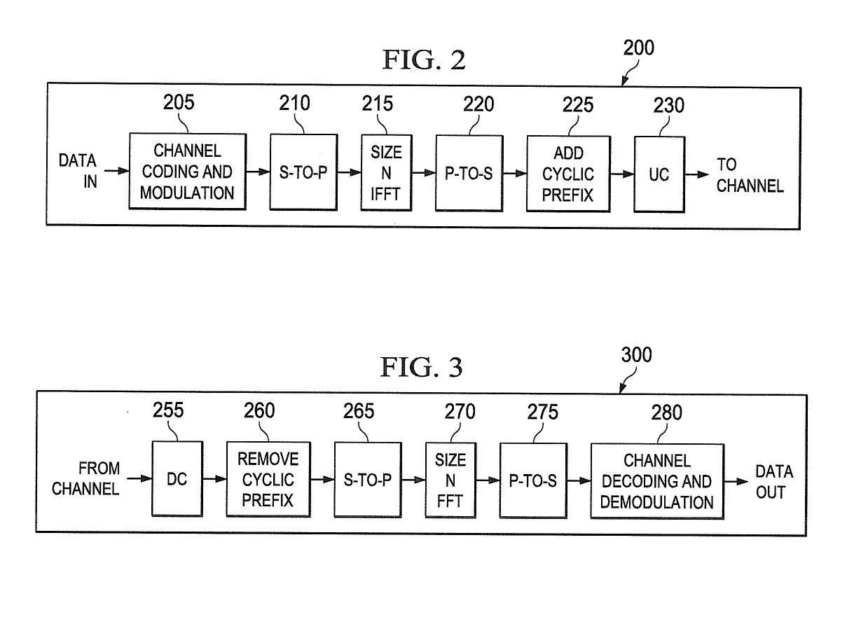

FIG. 2 is a high-level diagram of a wireless transmit path. FIG. 3 is a high-level diagram of a wireless receive path. In FIGS. 2 and 3, the transmit path 200 may be implemented, e.g., in eNB 102 and the receive path 300 may be implemented, e.g., in a UE, such as UE 116 of FIG. 1. It will be understood, however, that the receive path 300 could be implemented in an eNB (e.g. eNB 102 of FIG. 1) and the transmit path 200 could be implemented in a UE.

Transmit path 200 comprises channel coding and modulation block 205, serial-to-parallel (S-to-P) block 210, Size N Inverse Fast Fourier Transform (IFFT) block 215, parallel-to-serial (P-to-S) block 220, add cyclic prefix block 225, up-converter (UC) 230. Receive path 300 comprises down-converter (DC) 255, remove cyclic prefix block 260, serial-to-parallel (S-to-P) block 265, Size N Fast Fourier Transform (FFT) block 270, parallel-to-serial (P-to-S) block 275, channel decoding and demodulation block 280.

At least some of the components in FIGS. 2 and 3 may be implemented in software while other components may be implemented by configurable hardware (e.g., a processor) or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and should not be construed to limit the scope of the disclosure. It will be appreciated that in an alternate embodiment of the disclosure, the Fast Fourier Transform functions and the Inverse Fast Fourier Transform functions may easily be replaced by Discrete Fourier Transform (DFT) functions and Inverse Discrete Fourier Transform (IDFT) functions, respectively. It will be appreciated that for DFT and IDFT functions, the value of the N variable may be any integer number (i.e., 1, 2, 3, 4, etc.), while for FFT and IFFT functions, the value of the N variable may be any integer number that is a power of two (i.e., 1, 2, 4, 8, 16, etc.).

In transmit path 200, channel coding and modulation block 205 receives a set of information bits, applies coding (e.g., LDPC coding) and modulates (e.g., Quadrature Phase Shift Keying (QPSK) or Quadrature Amplitude Modulation (QAM)) the input bits to produce a sequence of frequency-domain modulation symbols. Serial-to-parallel block 210 converts (i.e., de-multiplexes) the serial modulated symbols to parallel data to produce N parallel symbol streams where N is the IFFT/FFT size used in eNB 102 and UE 116. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal. Finally, up-converter 230 modulates (i.e., up-converts) the output of add cyclic prefix block 225 to RF frequency for transmission via a wireless channel. The signal may also be filtered at baseband before conversion to RF frequency.

The transmitted RF signal arrives at UE 116 after passing through the wireless channel and reverse operations to those at eNB 102 are performed. Down-converter 255 down-converts the received signal to baseband frequency and remove cyclic prefix block 260 removes the cyclic prefix to produce the serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of modulated data symbols. Channel decoding and demodulation block 280 demodulates and then decodes the modulated symbols to recover the original input data stream.

Each of eNBs 101-103 may implement a transmit path that is analogous to transmitting in the downlink to UEs 111-116 and may implement a receive path that is analogous to receiving in the uplink from UEs 111-116. Similarly, each one of UEs 111-116 may implement a transmit path corresponding to the architecture for transmitting in the uplink to eNBs 101-103 and may implement a receive path corresponding to the architecture for receiving in the downlink from eNBs 101-103.

One of the objectives of the 3GPP Rel-11 work item “LTE Carrier Aggregation Enhancements” is to specify the support of the use of multiple timing advances in case of LTE uplink carrier aggregation (see also REF1). A timing advance of uplink transmission is performed by a UE to achieve uplink timing synchronization with the network.

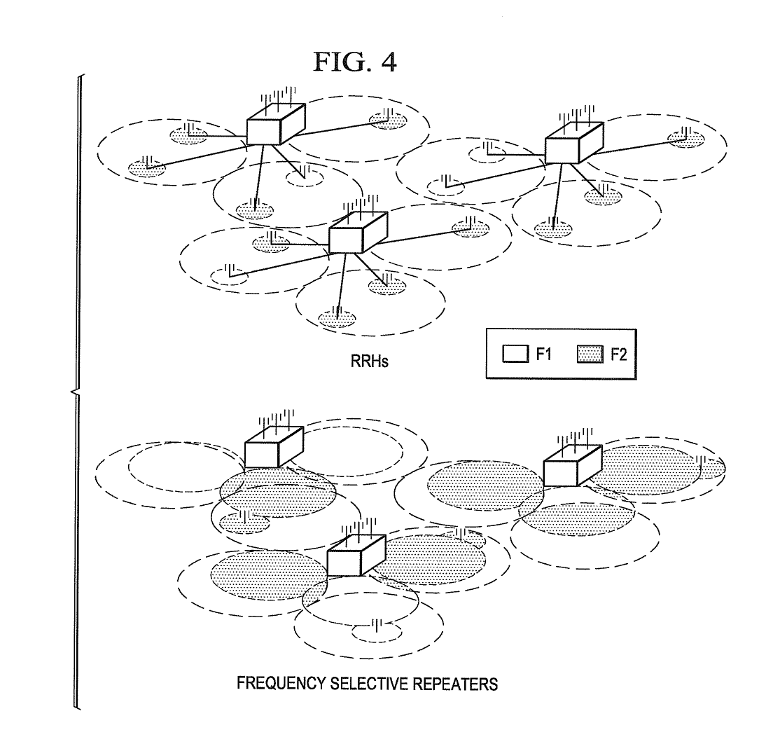

The support of multiple timing advances for LTE uplink carrier aggregation may be needed for cellular deployment scenarios where two aggregated cells are not co-located. For example, as shown in FIG. 4, one cell (e.g., a primary cell or PCell) can be used to provide macro coverage which is managed by a base station or eNodeB, and another cell (e.g., a secondary cell or SCell) can be used to provide local coverage within the macro coverage. The SCell can be attached to a remote radio head (RRH) (top of FIG. 4) or a frequency selective repeater (bottom of FIG. 4). The deployment scenarios are described in greater detail below. It has been agreed in the RAN2#73bis meeting that all deployment scenarios listed in REF2 are not precluded from the support of multiple timing advances. A group of cells that share the same UL timing is referred to as a Timing Advance Group (TAG).

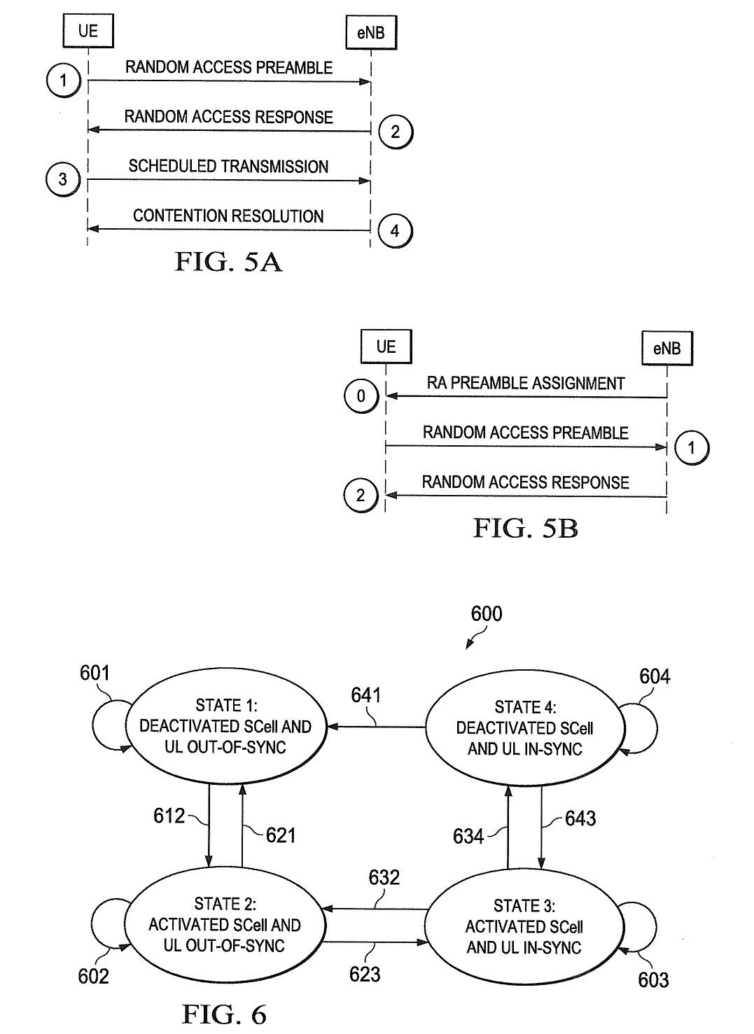

One method to enable multiple timing advances is to support random access procedures on the SCell, which does not share the same timing advance as the PCell. The current random access procedures for LTE are illustrated in FIGS. 5A and 5B. FIG. 5A illustrates a contention-based random access procedure, and FIG. 5B illustrates a non-contention based random access procedure. The steps for the random access procedures are described in Section 10.1.5 of REF3. For example, as shown in FIG. 5A, in LTE Release 10 (“Rel-10”), in a contention-based random access procedure, steps 1, 2 and 3 occur on the PCell while the contention resolution (step 4) can be cross-scheduled by the PCell (i.e., the actual DL assignment is for the SCell). As shown in FIG. 5B, in a non-contention-based random access procedure, step 0, step 1, and 2 occur on the PCell.

In Rel-10, the UE has a configurable timer, identified as timeAlignmentTimer, which is used to control Uplink Time Alignment. Uplink Time Alignment is associated with how long the UE is considered to be aligned with the network for uplink communication. This duration is configured by the information element (IE) TimeAlignmentTimer, as shown in Table 1 below (see also REF5 and REF6). In Table 1, the value sf500 corresponds to 500 sub-frames, value sf750 corresponds to 750 sub-frames, and so forth.

TABLE 1
TimeAlignmentTimer information element (IE)

-- ASNISTART

| | |
|---|---|
| TimeAlignmentTimer ::= | ENUMERATED { |

| | |
|---|---|
| | sf500, sf750, sf1280, sf1920, sf2560, |
| -- ASN1STOP | sf5120, sf10240, infinity} |

The maintenance of Uplink Time Alignment is detailed in Sec 5.2 of REF5. In general, the timeAlignmentTimer is started or restarted by the UE upon receiving a Timing Advance Command in a MAC control element or in a Random Access Response message. After the expiry of the timeAlignmentTimer, the corresponding cell is considered by the UE to be UL out-of-sync. In Rel-10, uplink time alignment is common for all serving cells. That is, during the active duration of the timeAlignmentTimer, all serving cells are considered to be UL aligned. Likewise, after the expiry of the timeAlignmentTimer, all serving cells are considered to be UL out-of-sync.

In accordance with two alternatives, a separate timeAlignmentTimer may or may not be required for the SCell that uses a different timing advance than that of the PCell. Multiple cells having UL to which the same timing advance applies can be grouped in a timing advance group (TAG). If a TAG includes the PCell, it is called the primary TAG (pTAG). If a TAG includes only one or more SCells, it is called a secondary TAG (sTAG). The two alternatives are described below (see also REF7 and REF8).

Alternative 1: The UE maintains an independent timeAlignmentTimer for the SCell/sTAG. The timeAlignmentTimer is started or restarted by the UE upon receiving the Timing Advance Command for the SCell/sTAG in a MAC control element or in a Random Access Response message for a SCell of the sTAG. After the expiry of the timeAlignmentTimer, the SCell/sTAG is considered by the UE to be UL out-of-sync. The configuration of the SCell/sTAG's TimeAlignmentTimer may or may not be the same as the PCell/pTAG's TimeAlignmentTimer.

Alternative 2: The UE does not maintain a separate timeAlignmentTimer for the SCell/sTAG. After receiving the Timing Advance Command in a Random Access Response message for a SCell of the sTAG (or any other method used to achieve UL synchronization), the UE assumes the SCell/sTAG is uplink synchronized if instructed to transmit in the uplink by the eNodeB. The UE still adjusts the uplink timing of the SCell/sTAG according to the timing advance command for the SCell/sTAG.

In both Alternative 1 and 2, the UL synchronization status of the PCell/pTAG may also influence the UL synchronization status of the SCell/sTAG assumed by the UE. In particular, if the PCell/pTAG is UL out-of-sync, then the UE may also assume that the SCell/sTAG is UL out-of-sync, although the SCell/sTAG has a different UL timing (or, equivalently, in Alternative 1, the SCell/sTAG's timeAlignmentTimer expires).

For Alternative 1, four SCell activation/deactivation and UL synchronization states can be classified as follows:

State 1: Deactivated SCell (UL out-of-sync)—no UL transmission is possible, including the physical random access channel (PRACH);

State 2: Activated SCell (UL out-of-sync)—no UL transmission is possible, except for the PRACH;

State 3: Activated SCell (UL in-sync)—normal UL transmission is possible, including sounding reference signal (SRS), physical uplink shared channel (PUSCH);

State 4: Deactivated SCell (UL in-sync)—no UL transmission possible, including the PRACH.

FIG. 6 illustrates a state diagram 600 for the four SCell activation/deactivation and UL synchronization states for Alternative 1 listed above. The state diagram 600 shows the four states, State 1 through State 4. In addition, the state diagram 600 shows four state operations 601-604 corresponding to the four states.

In State 1, a SCell deactivation command is received in a MAC control element (CE), and the UE's timeAlignmentTimer for the SCell is not running, as indicated at 601. In State 2, a SCell activation command is received in a MAC CE, and the UE's timeAlignmentTimer for the SCell is not running, as indicated at 602. In State 3, an SCell activation command is received in a MAC CE and the UE's timeAlignmentTimer for the SCell is running, or a Timing Advance Command is received in a MAC CE, as indicated at 603. In State 4, a SCell deactivation command is received in a MAC CE, and the UE's timeAlignmentTimer for the SCell is running, as indicated at 604. A SCell is by default deactivated after it is configured/added.

The state diagram 600 also shows a number of state transition operations 612-643. In operation 612, an SCell activation command is received at the UE in a MAC CE. In operation 621, an SCell deactivation command is received at the UE in a MAC CE, or the deactivation timer expires. In operation 623, a Timing Advance Command is received at the UE in a Random Access Response message for the SCell, another SCell in the same sTAG, or in a MAC CE. In operation 632, the timeAlignmentTimer for the SCell/sTAG expires or a random access contention resolution step fails. In operation 634, an SCell deactivation command is received at the UE in a MAC CE, or the deactivation timer expires. In operation 641, the timeAlignmentTimer for the SCell/sTAG expires. In operation 643, an SCell activation command is received at the UE in a MAC CE.

It is noted that some simplification is possible if State 4 is considered invalid. In this situation, the UE assumes that the SCell/sTAG timeAlignmentTimer expires when the SCell is deactivated. It is further noted that the IE TimeAlignmentTimer for the SCell need not be configured if the timer is the same as the PCell's.

Thus, for Alternative 2, three SCell activation/deactivation and UL synchronization states can be classified as follows:

State 1: Deactivated SCell—no UL transmission is possible including the PRACH;

State 2: Activated SCell (UL out-of-sync)—no UL transmission is possible, except for the PRACH;

State 3: Activated SCell (UL in-sync)—Normal UL transmission is possible, including SRS, PUSCH.

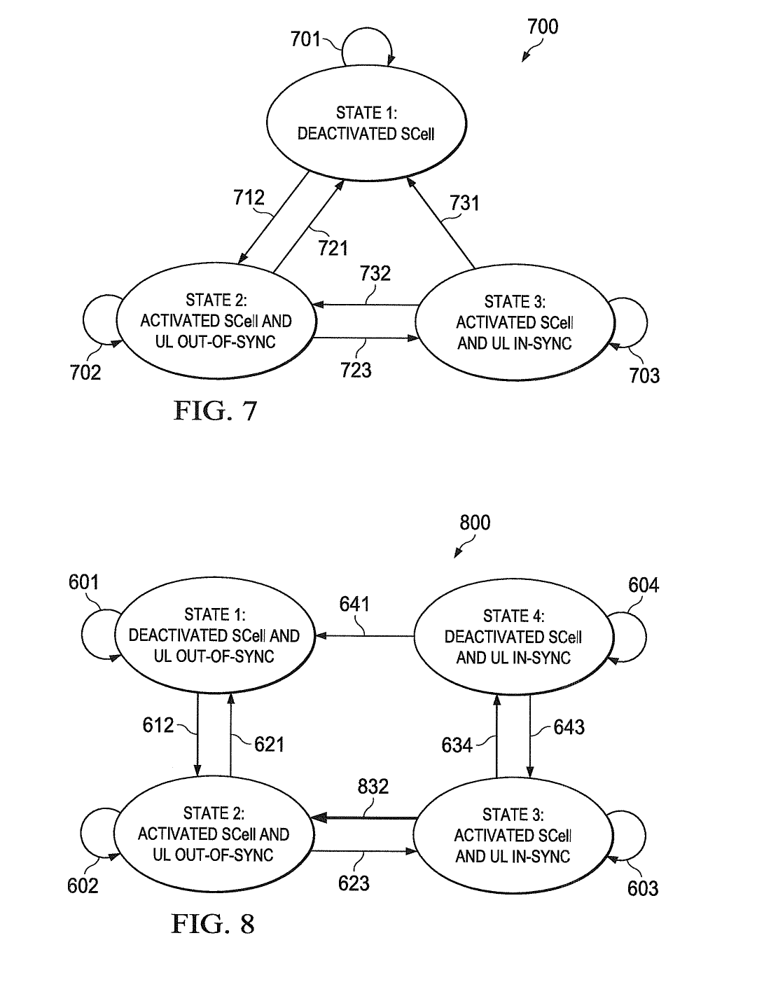

FIG. 7 illustrates a state diagram 700 for the three SCell activation/deactivation and UL synchronization states for Alternative 2 listed above. The state diagram 700 shows the three states, State 1 through State 3 (State 4 is considered invalid). In addition, the state diagram 700 shows three state operations 701-703 corresponding to the three states.

In State 1, an SCell deactivation command is received in a MAC CE, as indicated at 701. In State 2, an SCell activation command is received in a MAC CE, as indicated at 702. In State 3, a SCell activation command is received in a MAC CE, or a Timing Advance Command is received in a MAC CE, as indicated at 703. A SCell is by default deactivated after it is configured/added.

The state diagram 700 also shows a number of state transition operations 712-731. Operations 712, 721, 723, and 731 are analogous to operations 612, 621, 623, and 631, respectively, of FIG. 6. Thus, these operations will not be explained in greater detail. In operation 732, the timeAlignmentTimer for the PCell/pTAG expires (in contrast to the SCell/sTAG's timeAlignmentTimer expiring in operation 632), or a random access contention resolution step fails.

One advantage of Alternative 2 over Alternative 1 is reduced complexity for the UE implementation since no timer is maintained by the UE for the SCell(s). However, unlike Alternative 1, Alternative 2 doesn't promote a flexible transition between State 2 and State 3. For Alternative 2, the UE assumes the SCell is UL synchronized throughout the activation lifetime of the SCell after successful completion of the random access procedure for the SCell. However, if uplink synchronization has been lost for the activated SCell due to, e.g., timing advance command reception failure for the SCell, or the eNodeB intentionally stops sending the timing advance command, the UL transmission (such as the periodic SRS) is disconfigured by the Radio Resource Control (RRC) to avoid UL interference.

Furthermore, a transition to State 3 from State 2 also means that RRC signaling is performed if periodic SRS is needed. Transition between State 2 and State 3 is potentially frequent; however the resulting frequent RRC reconfiguration is not desirable. Alternative 2 may also be more susceptible to UL interference in the SCell caused by false detection of the UL grant for the SCell when the UE is, in fact, not UL synchronized to the SCell but still considers itself to be in State 3.

In accordance with embodiments of this disclosure, a number of enhancements may be made to Alternative 1 and Alternative 2.

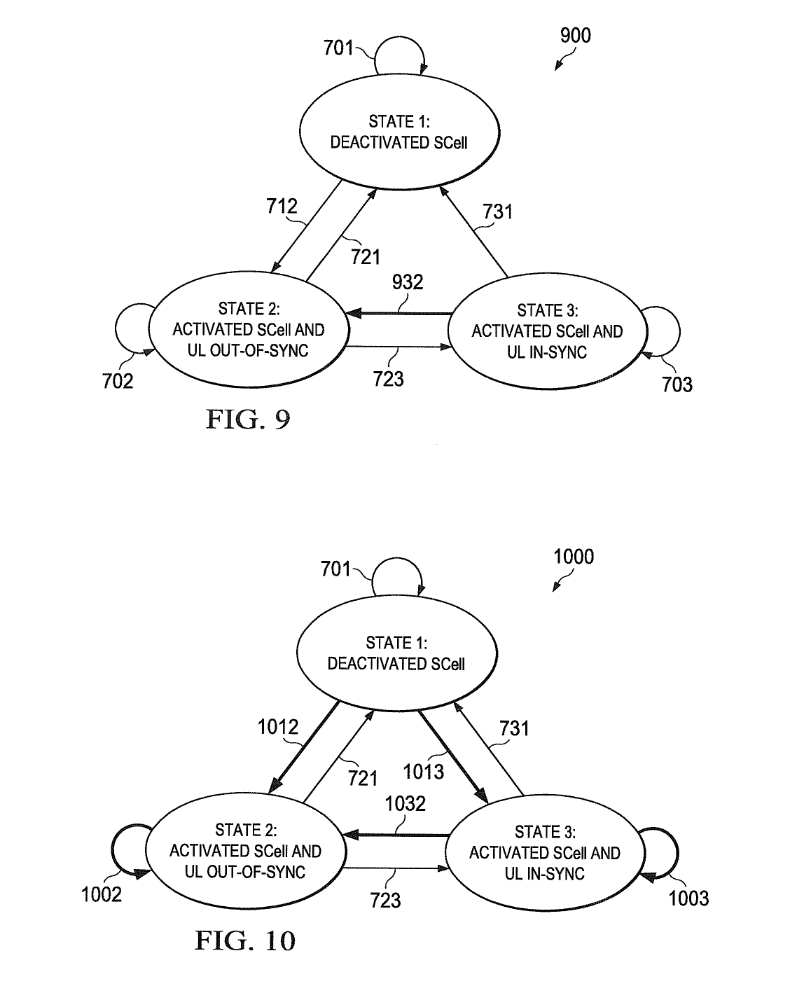

FIGS. 8 and 9 illustrate state diagrams that depict using a physical downlink control channel (PDCCH) order to transition from State 3 to State 2, according to embodiments of this disclosure. FIG. 8 illustrates use of the PDCCH order for Alternative 1 and FIG. 9 illustrates use of the PDCCH order for Alternative 2.

The state diagram 800 in FIG. 8 shows the four SCell activation/deactivation and UL synchronization states for Alternative 1 shown in FIG. 6. The state diagram 800 also shows the four state operations 601-604 and the state transition operations 612, 621, 623, 634, 641, 643 shown in FIG. 6.

Like transition operation 632, transition operation 832 may be triggered by expiration of the timeAlignmentTimer for the SCell/sTAG or failure of a random access contention resolution step. However, in FIG. 8, transition operation 832 may also be triggered by the UE receiving a PDCCH order to initiate a random access procedure for the SCell (or any SCell in the same sTAG).

The state diagram 900 in FIG. 9 shows the three SCell activation/deactivation and UL synchronization states for Alternative 2 shown in FIG. 7. The state diagram 900 also shows the three state operations 701-702 and the state transition operations 712, 721, 723, and 731 shown in FIG. 7.

Like transition operation 732, transition operation 932 may be triggered by expiration of the timeAlignmentTimer for the SCell/sTAG or failure of a random access contention resolution step. However, in FIG. 9, transition operation 932 may also be triggered by the UE receiving a PDCCH order to initiate a random access procedure for the SCell (or any SCell in the same sTAG).

Since the random access channel (RACH) on the SCell may only be used for achieving UL synchronization with the SCell (unlike for the PCell where the RACH is also used for scheduling requests if the PUCCH resource is not available), the PDCCH order to initiate a random access procedure for the SCell informs the UE that the UL synchronization for the SCell/sTAG has been lost and the eNodeB is attempting to reestablish UL synchronization for the SCell/sTAG.

This enhancement reduces the probability of UL interference. The benefit of avoiding UL interference avoidance is significant where the random access procedure initiated by the PDCCH order does not succeed the first time. Additionally, more refined condition is possible, e.g., transition operation 832/932 is only triggered if the PDCCH order is to initiate random access procedure on the same SCell that was also used for the previous random access procedure that achieved UL synchronization. If the PDCCH order is for a different SCell in the same sTAG (e.g., for probing purposes), transition operation 832/932 may not be triggered. It is also possible that whether the UE should comply with the additional condition can be configured by the network.

In accordance with another embodiment of the present disclosure, if periodic SRS is configured for the SCell/sTAG, the UE assumes Alternative 1 for the timeAlignmentTimer. Otherwise, if periodic SRS is not configured for the SCell/sTAG, the UE assumes Alternative 2 for the timeAlignmentTimer.

If periodic SRS is configured, Alternative 2 requires the SCell to be in-sync to avoid UL interference even though the UE may not need to transmit any UL data (but DL data is required, thus the SCell remains active). This may result in additional signaling overhead and eNodeB/UE processing. Nevertheless, Alternative 2 is simpler and effective if periodic SRS is not configured (and relying only on aperiodic SRS).

Alternative 1 allows the SCell/sTAG to go out-of-sync upon the expiry of the timer if the eNodeB determines not to maintain UL synchronization. Periodic SRS configuration does not need to be released via RRC signaling since the UE automatically stops UL transmission when it is out-of-sync. Upon returning to State 3 from State 2, the periodic SRS transmission can resume without RRC reconfiguration. Nevertheless, Alternative 1 is more complex since there are more timers and more states to be maintained by the UE and the eNodeB.

This enhancement allows the network the choice to configure either Alternative 1 or Alternative 2 depending on the conditions of the network. Periodic SRS configuration is a suitable switching condition since Alternative 2 is effective without configuration of periodic SRS and Alternative 1 is beneficial if periodic SRS is configured.

FIG. 10 illustrates a state diagram that depicts an enhancement to Alternative 2, according to an embodiment of this disclosure. In the enhancement to Alternative 2, the UL synchronization status indicator is included in SCell activation MAC CE.

The state diagram 1000 in FIG. 10 shows the three SCell activation/deactivation and UL synchronization states for Alternative 2 shown in FIG. 7. The state diagram 1000 also shows the state operation 701 and the state transition operations 721, 723, and 731 shown in FIG. 7.

In the embodiment shown in FIG. 10, SCell activation commands received in the MAC CE with an UL in-sync indicator enable transitions to State 3. Likewise, SCell activation commands received in the MAC CE with an UL out-of-sync indicator enable transitions to State 2. Thus, transition operation 1013 may be triggered by an SCell activation command received in the MAC CE with an UL in-sync indicator. Likewise, transition operations 1012 and 1032 may be triggered by an SCell activation command received in the MAC CE with an UL out-of-sync indicator. State operation 1002 includes the UL out-of-sync indicator, and state operation 1003 includes the UL in-sync indicator.

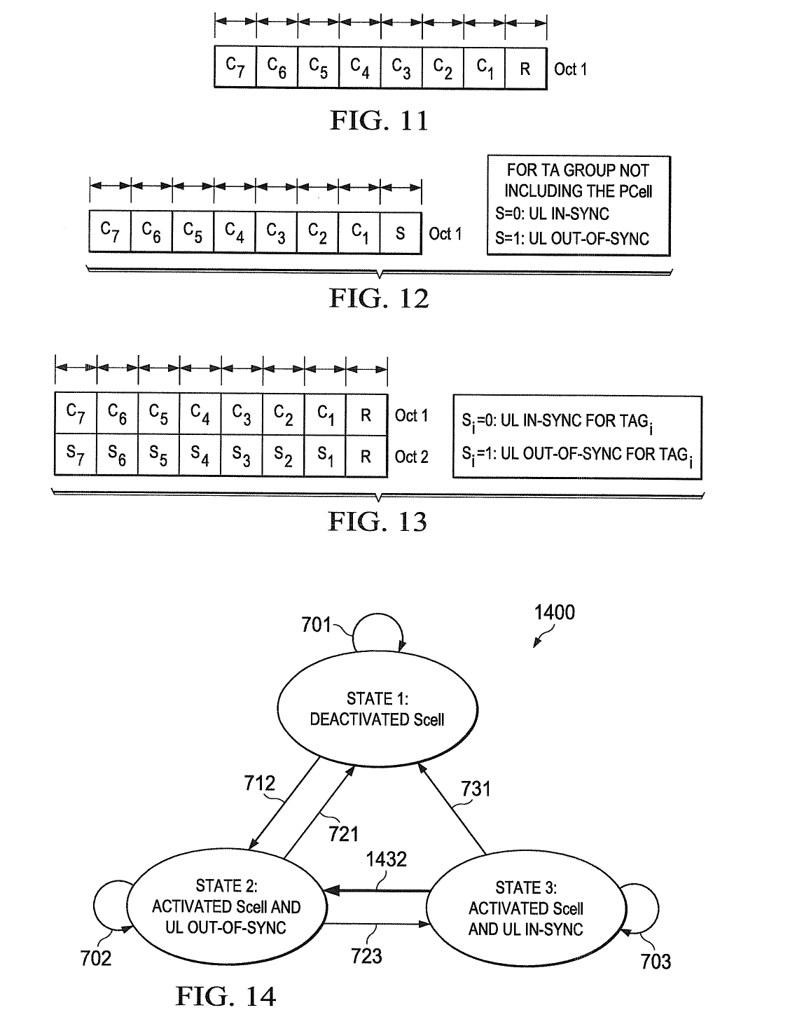

FIG. 11 illustrates the Rel-10 activation/deactivation MAC control element design. The MAC CE has a fixed size and consists of a single octet containing seven C-fields and one R-field. Cᵢ indicates activation/deactivation for SCell i. R is a reserved bit, normally set to ‘0’.

FIG. 12 illustrates a MAC control element according to one embodiment of this disclosure. In the embodiment shown in FIG. 12, if there are only two TA groups configured, the one-bit R-field is used to indicate the UL synchronization status of the TA group not including the PCell. For example, a value ‘0’ may be used to indicate the cell(s) in the TA group are in-sync, and a value ‘1’ may indicate the cell(s) are out-of-sync. This is shown in FIG. 12 where the R-field has been renamed as the S-field. Alternatively, using a value ‘0’ to indicate an out-of-sync status may be advantageous in that such a use is backward compatible since in Rel-10 the SCell is considered in-sync after activation (provided that the PCell is still in-sync).

FIG. 13 illustrates a MAC control element according to another embodiment of this disclosure. In the embodiment shown in FIG. 13, one byte is added to the activation/deactivation MAC CE and is received only by UEs that support multiple TA. Compared to the embodiment of FIG. 12, the embodiment of FIG. 13 can indicate the UL synchronization status of more TA groups. The number of TA groups that can be addressed is either fixed or configurable. This is shown in FIG. 13 where the UL synchronization status of 7 TA groups (TAGs), not including the TA group with the PCell, is indicated.

FIG. 14 illustrates a state diagram that depicts an enhancement to Alternative 2, according to an embodiment of this disclosure. In this enhancement to Alternative 2, the MAC CE used as the Timing Advance Command for the SCell(s) of a Timing Advance Group is modified to indicate UL out-of-sync for the SCell(s).

The state diagram 1400 in FIG. 14 shows the three SCell activation/deactivation and UL synchronization states for Alternative 2 shown in FIG. 7. The state diagram 1400 also shows the state operations 701-703 and the state transition operations 712, 721, 723, and 731 shown in FIG. 7.

In the embodiment shown in FIG. 14, the UE in State 3 may receive a MAC CE as a Timing Advance Command for the SCell(s) of a Timing Advance Group. The MAC CE is modified to indicate UL out-of-sync for the SCell(s). After receiving the MAC CE, the UE transitions from State 3 to State 2, as indicated by the state transition operation 1432. This embodiment provides flexibility of transition between State 2 and State 3 for Alternative 2.

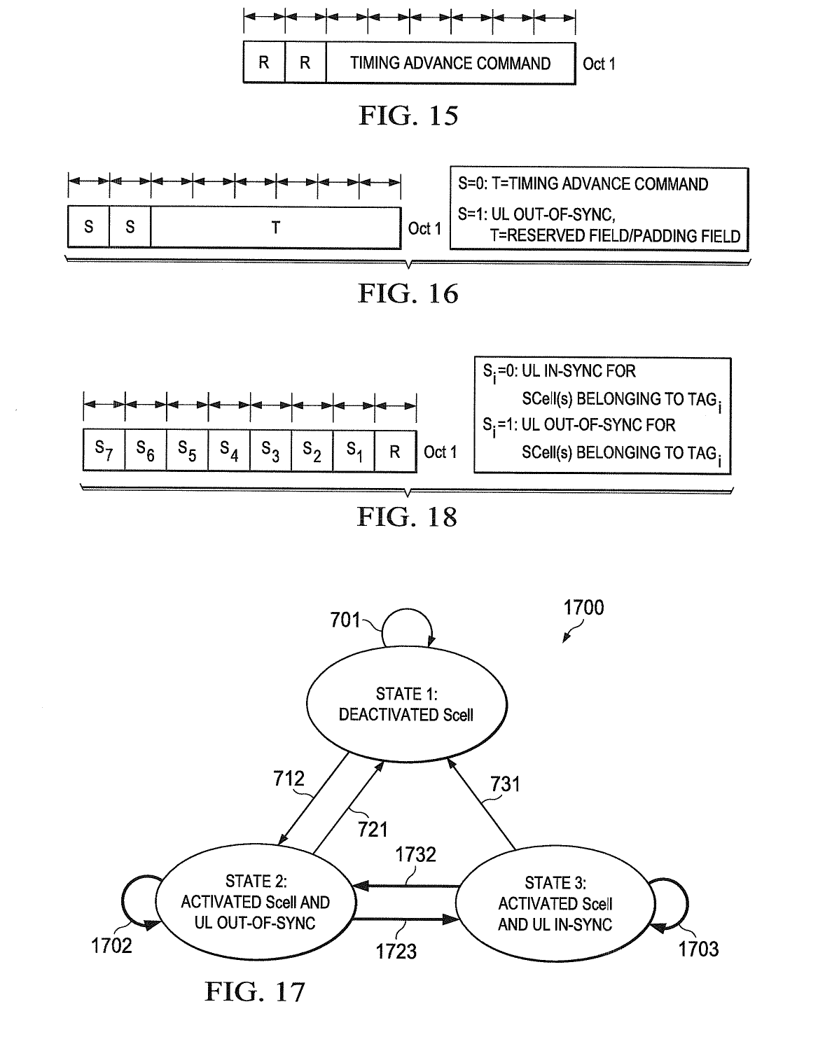

FIG. 15 illustrates the Timing Advance Command MAC CE in LTE Rel-10. The Timing Advance Command MAC CE has a fixed size and consists of a single octet having two reserved bits (set to ‘0’) and a Timing Advance Command field of 6 bits. Further details can be found in REF5.

FIG. 16 illustrates a Timing Advance Command MAC CE according to one embodiment of this disclosure. In the embodiment shown in FIG. 16, the two reserved bits in the TA Command MAC CE are used to indicate if the MAC CE is a normal Timing Advance Command MAC CE or if the UL is out-of-sync. As illustrated in FIG. 16, the R-field has been renamed as the S-field. In one example, S=0 indicates that the rest of the MAC CE should be interpreted as the Timing Advance Command field, and S=1 indicates that the rest of the MAC CE is a reserved field (or padding field).

FIG. 17 illustrates a state diagram that depicts an enhancement to Alternative 2, according to an embodiment of this disclosure. In this enhancement to Alternative 2, a new MAC CE, identified by a MAC PDU subheader with a new LCID, is used to indicate the UL synchronization status of the SCell(s). The number of TA groups that can be addressed is either fixed or configurable.

The state diagram 1700 in FIG. 17 shows the three SCell activation/deactivation and UL synchronization states for Alternative 2 shown in FIG. 7. The state diagram 1700 also shows the state operation 701 and the state transition operations 712, 721, and 731 shown in FIG. 7.

Two enhancements for Alternative 2 are shown in FIG. 17. In one enhancement, a UE transition to State 2 may be triggered upon receiving the MAC CE indicating UL out-of-sync, as indicated by state transition operation 1732 and state operation 1702. In another enhancement, a UE transition to State 3 may be triggered upon receiving the MAC CE indicating UL in-sync, as indicated by state transition operation 1723 and state operation 1703. This embodiment provides flexibility of transition between State 2 and State 3 for Alternative 2.

The new LCID for the new MAC CE can be created as shown in Table 2 below. FIG. 18 illustrates one example of the new MAC CE according to an embodiment of this disclosure. As shown in FIG. 18, Sᵢ is used to indicate the UL synchronization status of the SCell(s) corresponding to TAGᵢ and R is the reserved bit.

TABLE 2
Values of LCID for DL-SCH

| Index | LCID values |
|---|---|
| 00000 | CCCH |
| 00001-01010 | Identity of the logical channel |
| 01011-11001 | Reserved |
| 11010 | UL synchronization status |
| 11011 | Activation/Deactivation |
| 11100 | UE Contention Resolution Identity |
| 11101 | Timing Advance Command |
| 11110 | DRX Command |
| 11111 | Padding |

In accordance with an embodiment of this disclosure, the change in the TAG ID for a cell (e.g., via higher-layer reconfiguration of TAGs) causes the cell/sTAG's UL synchronization status to be UL out-of-sync. For Alternative 1, this is equivalent to the expiry of the cell/sTAG's timeAlignmentTimer.

In an alternative, the change in the TAG ID for a cell does not affect the cell's UL synchronization status, e.g., for Alternative 1, the cell/sTAG's synchronization depends on the status of the timeAlignmentTimer only.

In another alternative, the effect of the change in the TAG ID on a cell's UL synchronization status is configured by the eNodeB (i.e., the eNodeB may configure whether or not the change of the TAG ID causes the cell to be UL out-of-sync). Thus, the configuration is given once and its indication is assumed by the UE for subsequent TAG ID changes, until the next reconfiguration. Alternatively, the configuration is given with every TAG ID change.

Enhancements to UE-Initiated Random Access Procedure

Another issue under discussion in 3GPP TSG RAN WG2 is whether the UE should be able to initiate a random access procedure on a SCell. The embodiments described below provide a framework to facilitate a UE-initiated random access procedure on an SCell.

Returning to the RRH scenario shown in the top of FIG. 4, it is assumed that the F1 carrier is configured to be the PCell and the F2 carrier is configured to be the SCell. Due to temporary inactivity by the UE, an RRC-connected UE may not be UL synchronized to both the PCell and the SCell. When such a UE determines to send UL data or control information, there are three possible procedures (hereinafter referred to as “Proc 1”, “Proc 2”, and “Proc 3”) depending on whether the eNodeB schedules the uplink transmission on the PCell or the SCell. One procedure is used when the eNodeB schedules the UL transmission on the PCell. The other two procedures may be used when the eNodeB schedules the UL transmission on the SCell.

Proc 1: When the eNodeB schedules the UL transmission on the PCell, the UE initiates a random access procedure to the PCell. Upon successful completion of the random access procedure, the eNodeB schedules an uplink transmission on the PCell.

When the eNodeB schedules the UL transmission on the SCell, there are two possible procedures. In one procedure (Proc 2), the UE initiates a random access procedure to the PCell. Upon successful completion of the random access procedure on the PCell, the eNodeB initiates a random access procedure for the SCell so that the UE can achieve uplink synchronization for the SCell. Upon successful completion of the random access procedure on the SCell, the eNodeB schedules an uplink transmission on the SCell. In the other of the two procedures (Proc 3), the UE initiates a random access procedure to the SCell. Upon successful completion of the random access procedure, the eNodeB schedules an uplink transmission on the SCell.

Scheduling uplink transmission on the SCell may be advantageous in that the required uplink transmission power is typically smaller than that of the PCell due to the smaller path loss to the SCell. If the network schedules the uplink transmission on the SCell, enabling Proc 3 as opposed to Proc 2 may reduce the latency for uplink transmission of UE's data.

It is noted that the benefit of the UE-initiated random access procedure on the SCell is not limited to the RRH scenario in FIG. 4. A UE-initiated random access procedure on the SCell can also enable the eNodeB to manage the load of the RACH for all configured cells in all carrier aggregation deployment scenarios. It is also noted that the UE-initiated random access procedure on the SCell is also beneficial when the SCell is associated with a different eNodeB than that of the PCell in a so-called inter-eNodeB carrier aggregation operation.

In the embodiments described below, it is assumed that carrier aggregation and multiple timing advances have been configured to the UE.

In one embodiment (hereinafter referred to “Embodiment 1”), the UE may initiate a random access procedure on the SCell if the following condition is satisfied:

Information associated with contention-based random access for the SCell has been configured by higher layer signaling (e.g., RRC). The information concerned is similar to the information included in IE PRACH-Config and IE RACH-ConfigCommon (see REF6). This information can be dedicatedly signaled to the UE. The eNodeB determines if the configuration is required based on, e.g., estimated location information of the UE, RSRP reports for the configured cells by the UE, RACH loading of the cells, and the like.

In one variation of Embodiment 1, in addition to the above condition being met, the UE may initiate the random access procedure on the SCell only if the UL synchronization status for the PCell and the SCell(s) is “non-synchronized” and the UE has uplink data/control information to transmit.

The UE-initiated random access procedure on the SCell is turned off when the higher-layer configuration of the resources associated with contention-based random access for the SCell is released.

One advantage of Embodiment 1 is a simple design. The configuration of information for contention-based random access for the SCell serves as the indication to the UE that the UE should initiate a random access procedure on the SCell when the other conditions are also satisfied.

In another embodiment (hereinafter referred to “Embodiment 2”), the UE may initiate a random access procedure on the SCell if the following two conditions are satisfied:

(1) Information associated with contention-based random access for the SCell has been configured by higher layer signaling (e.g., RRC). The information concerned is similar to the information included in IE PRACH-Config and IE RACH-ConfigCommon (see REF6). This information can be dedicatedly signaled to the UE. The eNodeB can determine whether to configure the information based on the deployment scenario (e.g., the eNodeB may always configure the information for the RRH scenario shown in FIG. 4).

(2) The path loss estimate for the SCell by the UE is lower than the path loss estimate for the PCell by the UE (as well as other candidate SCell(s) under consideration). In one alternative, the path loss difference has to be greater than a certain threshold X, which can be fixed or configurable by the higher layer. In other words, the condition can be described as:

Path loss for PCell−path loss for SCell>X [dB].

The path loss estimate for a cell is defined as in Rel-10:

Path loss=cell-specific reference signal (CRS) power for the cell−RSRP for the cell.

The cell-specific reference power for the cell is signaled by higher layer (see referenceSignalPower in REF6).

In one variation of Embodiment 2, in addition to the above conditions being met, the UE may initiate the random access procedure on the SCell only if the UL synchronization status for the PCell and the SCell(s) is “non-synchronized” and the UE has uplink data/control information to transmit.

The UE-initiated random access procedure on the SCell is turned off when the higher-layer configuration of the resources associated with contention-based random access for the SCell is released.

One advantage of Embodiment 2 is that frequent RRC reconfiguration of contention-based RACH by the eNodeB is avoided. Another advantage is that the UE can assess which cell is the preferred cell for uplink transmission based on the comparison of path loss estimates of the configured cells.

In yet another embodiment (hereinafter referred to as “Embodiment 3”), the UE may initiate a random access procedure on the SCell if the following conditions are satisfied:

(1) Information associated with contention-based random access for the SCell has been configured by higher layer signaling (e.g., RRC). The information concerned is similar to the information included in IE PRACH-Config and IE RACH-ConfigCommon (see REF6). This information can be dedicatedly signaled to the UE. The eNodeB can determine whether to configure the information based on the deployment scenario (e.g., the eNodeB may always configure the information for the RRH scenario shown in FIG. 4).

(2) The eNodeB provides an explicit indication to the UE that the UE should initiate random access procedure on the SCell (e.g., by Level 1 (L1), MAC or RRC signaling). The eNodeB makes the determination based on, e.g., estimated location information of the UE, RSRP reports for the configured cells by the UE, RACH loading of the cells, and the like.

In one variation of Embodiment 3, in addition to the above conditions being met, the UE may initiate the random access procedure on the SCell only if the UL synchronization status for the PCell and the SCell(s) is “non-synchronized” and the UE has uplink data/control information to transmit.

The UE-initiated random access procedure on the SCell is turned off when the higher-layer configuration of the resources associated with contention-based random access for the SCell is released or if indicated by the explicit indication described above.

One advantage of Embodiment 3 is that the eNodeB can reconfigure the target cell for the random access procedure with a smaller signaling overhead than that of Embodiment 1. Another advantage is that the flexibility provided to the eNodeB allows more efficient management of the RACH load across cells.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a user equipment (UE), a method for controlling synchronization with a secondary cell (SCell), the method comprising:
receiving a physical downlink control channel (PDCCH) order from an eNodeB associated with a SCell; and
in response to receiving the PDCCH order, transitioning from a first state where the UE considers the SCell in sync for an uplink transmission to a second state where the UE considers the SCell out of sync for the uplink transmission.

2. The method of claim 1, wherein the PDCCH order comprises an order to initiate a random access procedure between the UE and the SCell.

3. The method of claim 1, wherein in both the first and second states, the UE considers the SCell to be activated.

4. The method of claim 1, wherein in the first state a timeAlignmentTimer for the SCell is running.

5. The method of claim 1, wherein in the second state a timeAlignmentTimer for the SCell is not running.

6. A user equipment (UE) configured to control synchronization with a secondary cell (SCell), the UE comprising:
a processor configured to:
receive a physical downlink control channel (PDCCH) order from an eNodeB associated with a SCell; and
in response to receiving the PDCCH order, transition the UE from a first state where the UE considers the SCell in sync for an uplink transmission to a second state where the UE considers the SCell out of sync for the uplink transmission.

7. The UE of claim 6, wherein the PDCCH order comprises an order to initiate a random access procedure between the UE and the SCell.

8. The UE of claim 6, wherein in both the first and second states, the UE considers the SCell to be activated.

9. The UE of claim 6, wherein in the first state a timeAlignmentTimer for the SCell is running.

10. The UE of claim 6, wherein in the second state a timeAlignmentTimer for the SCell is not running.

11. For use in a user equipment (UE), a method for communicating with a secondary cell (SCell), the method comprising:
initiating a random access procedure to a SCell, wherein completion of the random access procedure causes an eNodeB associated with the SCell to schedule an uplink transmission on the SCell; and
transmitting on the uplink to the SCell according to the schedule.

12. The method of claim 11, wherein the random access procedure to the SCell is initiated only when information associated with contention-based random access for the SCell has been configured by higher layer signaling.

13. The method of claim 11, wherein the random access procedure to the SCell is initiated only when (1) information associated with contention-based random access for the SCell has been configured by higher layer signaling, and (2) a path loss estimate for the SCell by the UE is lower than a path loss estimate for an associated primary cell by the UE.

14. The method of claim 11, wherein the random access procedure to the SCell is initiated only when (1) information associated with contention-based random access for the SCell has been configured by higher layer signaling, and (2) the eNodeB provides an explicit indication to the UE that the UE should initiate random access procedure on the SCell.

15. The method of claim 11, wherein the SCell is coupled to a remote radio head (RRH).

16. A user equipment (UE) configured to communicate with a secondary cell (SCell), the UE comprising:
a processor configured to:
initiate a random access procedure to a SCell, wherein completion of the random access procedure causes an eNodeB associated with the SCell to schedule an uplink transmission on the SCell; and
transmit on the uplink to the SCell according to the schedule.

17. The UE of claim 16, wherein the processor initiates the random access procedure to the SCell only when information associated with contention-based random access for the SCell has been configured by higher layer signaling.

18. The UE of claim 16, wherein the processor initiates the random access procedure to the SCell only when (1) information associated with contention-based random access for the SCell has been configured by higher layer signaling, and (2) a path loss estimate for the SCell by the UE is lower than a path loss estimate for an associated primary cell by the UE.

19. The UE of claim 16, wherein the processor initiates the random access procedure to the SCell only when (1) information associated with contention-based random access for the SCell has been configured by higher layer signaling, and (2) the eNodeB provides an explicit indication to the UE that the UE should initiate random access procedure on the SCell.

20. The UE of claim 16, wherein the SCell is coupled to a remote radio head (RRH).
